(19) United States
(12) Patent Application Publication
(10) Pub. No.: US 2017/0206476 A1
(43) Pub. Date: Jul. 20, 2017

(54) GROUP ALLOTMENT OF NETWORK CAPACITY

(71) Applicant: Amadeus S.A.S., Biot (FR)

(72) Inventors: Benoit Lardeux, Roquefort-Les-Pins (FR); Matthieu Bareges, Biot (FR)

(21) Appl. No.: 14/995,933

(22) Filed: Jan. 14, 2016

(51) Int. Cl. G06Q 10/02

(52) U.S. Cl. CPC G06Q 10/025

(57) ABSTRACT

Systems, methods, and computer program products for allotting capacity from a network to a plurality of group requests. Each request defines a number of units of capacity and a node pair that includes an origin node and a destination node. An allotment module identifies one or more routes connecting the node pair, and defines a plurality of selector functions. Each function identifies a plurality of request-route pairs that are satisfied without exceeding an available capacity of any of the directional links in the network. The allotment module determines a value that would be generated by allotting, for each request-route pair identified by the selector function, the number of units of capacity defined by the respective request from the respective route. The allotment module may then rank the selector functions based on the values, and allot the capacity to the requests identified by the highest ranked selector function.

### BACKGROUND

The invention generally relates to computers and computer systems and, in particular, to methods, systems, and computer program products that allot units of capacity between multiple group requests.

Service providers can sell capacity in a market, such as seats on flights connecting an origin and a destination, on an individual basis and on a group basis. Individual sales may include single bookings for individual passengers or small groups of passengers. Group sales may include the sale of blocks of capacity to resellers, such as travel agents, tour operators, or corporate customers who have employees that travel between the same locations on a regular basis.

For some providers, group sales may represent a significant part of their overall business. However, managing group sales can present difficulties to the provider. Group sales are typically characterized by a lack of pre-defined, published fares. Group sales may also be difficult to price due to the inability of conventional revenue management systems to determine price and availability for large blocks of capacity.

Typically, entities that wish to purchase blocks of capacity will send group requests for the coming season to the provider. Based on the number of requests and amounts of capacity requested, the provider will allot capacity to the requests based on their ability to provide the capacity, the size of the request, and the priority of the requestor. The allotments may then be offered to the buyers and a price negotiated. To accommodate this lengthy process, groups sales may be negotiated well in advance (e.g., 6 to 12 months) of planned use, and inventory allotted to each group sale in a reservation system. Group sales are often more price sensitive than schedule sensitive, and often do not include a penalty for cancelation, even if the cancellation is made close to the departure date.

Because of the long lead times and lack of penalties, group requests tend to overestimate the need for capacity. This may create a relatively high probability of cancelations by the requestor prior to departure. Consequently, group sales can introduce a risk that some of the inventory which was allotted to a group request will go unused, and thus result in lost revenue for the provider.

Thus, improved systems, methods, and computer program products for determining how to allot capacity to group requests are needed to improve the utilization of provider capacity, and reduce wasted inventory.

### SUMMARY

In an embodiment of the invention, a system for allotting units of capacity in a network comprising a plurality of nodes connected by directional links is provided. The system includes one or more processors and a memory coupled to the processors. The memory stores data comprising program code that, when executed by the one or more processors, causes the system to receive a plurality of requests for group allotments, each request defining a number of units and a node pair that includes an origin node and a destination node. For each request, the system determines one or more routes, with each route including one or more directional links that connect the node pair. The system defines a plurality of selector functions, with each selector function identifying a plurality of request-route pairs that are satisfied without exceeding an available capacity of any of the directional links in the network. The system determines a value for each selector function that would be generated by allotting, for each request-route pair identified by the selector function, the number of units defined by the respective request from the respective route. The system may then rank the selector functions based on the values, and allot the capacity to the requests identified by the highest ranked selector function.

In another embodiment of the invention, a method of allotting units of capacity in the network is provided. The method includes receiving the plurality of requests for group allotments that define the number of units and the node pair, and determining the one or more routes for each request that include the one or more directional links that connect the node pair. The method defines the plurality of selector functions that identify the plurality of request-route pairs which are satisfied without exceeding the available capacity of any of the directional links in the network. The method determines the value for each selector function that would be generated by allotting, for each request-route pair identified by the selector function, the number of units defined by the respective request from the respective route. The method may then rank the selector functions based on the values, and allot the capacity to the requests identified by the highest ranked selector function.

In another embodiment of the invention, a computer program product is provided for allotting units of capacity in the network. The computer program product includes a non-transitory computer-readable storage medium including program code. The program code is configured, when executed by the one or more processors, to cause the one or more processors to receive the plurality of requests for group allotments, each request defining the number of units and the node pair. For each request, the code causes the processors to determine the routes that include the directional links that connect the node pair. The code causes the processors to define the plurality of selector functions, with each selector function identifying the plurality of request-route pairs that are satisfied without exceeding the available capacity of any of the directional links in the network. The code further causes the processors to determine the value for each selector function that would be generated by allotting, for each request-route pair identified by the selector function, the number of units defined by the respective request from the respective route. The code may then cause the processors to rank the selector functions based on the values, and allot the units to the requests identified by the highest ranked selector function.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including an allotment management system.

FIG. 2 is a diagrammatic view of an exemplary computer that may be used to provide the operating environment of FIG. 1.

FIG. 3 is a diagrammatic view of the allotment management system depicting an allotment module that determines an optimum allotment of travel network capacity to group requests.

### DETAILED DESCRIPTION

Embodiments of the invention are directed to systems, methods, and computer program products for allotting units of capacity to multiple group requests. Each group request may request an allotment of capacity on a route connecting a pair of nodes in a transportation network. The capacity may be provided from a route including one or more directional links which connect the pair of nodes either directly, or through an intermediate node. Group allotments may be part of a group series allotment, which may be a set of recurrent allotments of capacity that connect the same pair of nodes at different times. In the context of air travel, the group allotment may be a block of seats on a flight connecting a specified origin node to a specified destination node on a specified date.

Embodiments of the invention may be implemented using an allotment module that optimizes allotments from the available capacity of the transportation network. Optimizing allotments between group requests is a complex undertaking at least because determining the number of units to allot to each request typically involves a large number of possible combinations of allotments, node pairs, directional links, and requests. For example, the allotment module may be required to determine allotments for a large number of group requests. Each of these determinations may in turn involve a large number of parameters that need to be taken into account by the allotment module. The complexity may be further increased by the number of directional links from which routes are defined, and the number of nodes in the transportation network, which may require the allotment module to assess multiple interdependent directional links in order to optimize each of the allotments. For at least these reasons, optimizing allotments as described herein may require significant computational resources, such that the optimization cannot be performed in the human mind or by using pen and paper.

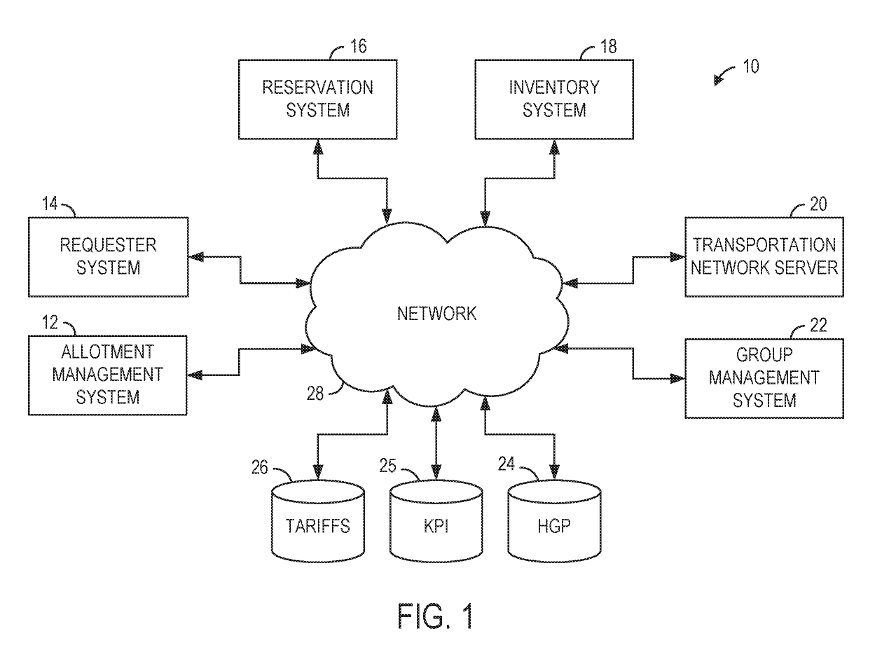

Referring now to FIG. 1, an operating environment 10 in accordance with an embodiment of the invention may include an allotment management system 12, a requestor system 14, a reservation system 16, an inventory system 18, a transportation network server 20, and a group management system 22. The operating environment may also include a Historical Group Performance (HGP) database 24, a Key Performance Indicator (KPI) database 25 for storing KPIs, and a tariffs database 26 for storing tariffs associated with the transportation network. In particular, the HGP database 24 may store data relating to the historical revenue performance of previous group request allotments. This historical data may define the overall performance of previous allotments based on a combination of the requestor's capability to meet commitments and the volume of requested sales from the allotment.

Each of the allotment management system 12, requestor system 14, reservation system 16, inventory system 18, transportation network server 20, group management system 22, HGP database 24, KPI database 25, and tariffs database 26 may communicate through a data network 28. The data network 28 may include one or more private or public data networks (e.g., the Internet) that enable the exchange of data between systems connected to the data network 28.

The requestor system 14 may be operated by a travel agency, tour operator, charter service, corporate travel department, or any other entity that issues group requests for block allotments of capacity from the transportation network. To this end, the requestor system 14 may include one or more applications that allow users to define and issue group requests, as well as other types of reservation requests.

The reservation system 16 may be configured to store and retrieve data, and conduct transactions related to the purchase of air travel, hotels, car rental, or other travel related products and services. The reservation system 16 may thereby enable travel agents, tour operators, corporate travel offices, or other system users to book travel related products and services using either individual or group reservations. The reservation system 16 may manage reservations for a single provider of transportation services, or may be configured to manage reservations for multiple providers. In cases where the reservation system 16 manages reservations for multiple providers, the reservation system 16 may include, or be part of, a Global Distribution System (GDS) configured to facilitate communication between the requestor system 14 and one or more reservation systems, the group management system 22, or other systems with which the requestor system 14 communicates. To this end, the reservation system 16 may maintain data links to a plurality of provider and/or other reservation systems via the data network 28. These data links may enable the reservation system 16 to route requests from the requestor system 14 to a corresponding provider of the product or service being requested.

The inventory system 18 may maintain a database of available transportation network capacity, which may be measured in units of capacity, or simply “units”. A unit of capacity may include, for example, an available seat on a flight connecting an origin to a destination. The inventory system 18 may determine availability and pricing for the units, and may be integrated with the reservation system 16, or provided as a separate system. The inventory system 18 may define how many units are available on a particular directional link, or between a particular node pair, by opening and closing individual booking classes in accordance with rules defined by the provider or a revenue management system. In the context of air travel, an available unit of capacity in the inventory system 18 may not necessarily correspond to a specific physical seat on an aircraft. For example, available capacity may exceed the number of physical seats in a market to allow for overbooking.

The transportation network server 20 may maintain a database of directional links organized by the time during which each directional link provides capacity, and the identity of a departure node and an arrival node connected by the directional link. The transportation network server 20 may thereby define a transportation network that provides units of capacity which are allotted to the group requests. In a transportation network provided by an air carrier, each directional link may represent a leg, or the non-stop operation of an aircraft from a scheduled departure station to the next scheduled arrival station during a specific period of time. Thus, directional links may provide the elemental components from which the inventory system 18 defines segments connecting origin nodes to destination nodes.

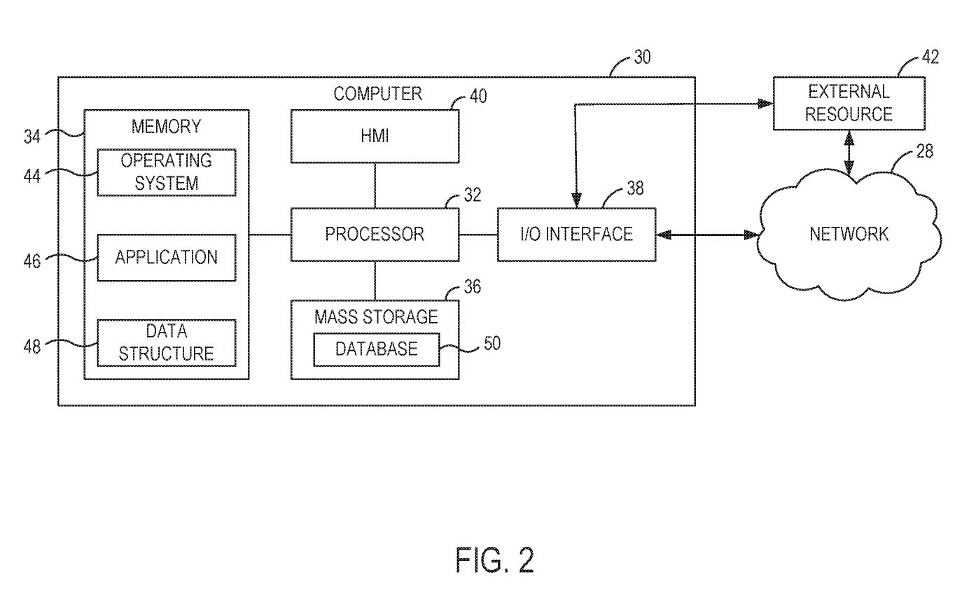

Referring now to FIG. 2, the allotment management system 12, requestor system 14, reservation system 16, inventory system 18, transportation network server 20, group management system 22, HGP database 24, KPI database 25, tariffs database 26, and data network 28 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the data network 28 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, or application 46 to store or manipulate data.

The I/O interface 38 may provide a machine interface that operatively couples the processor 32 to other devices and systems, such as the data network 28 or external resource 42. The application 46 may thereby work cooperatively with the data network 28 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, persons having ordinary skill in the art will understand that embodiments of the invention may include applications that are located externally to the computer 30, distributed among multiple computers or other external resources 42, or provided by computing resources (hardware and software) that are provided as a service over the data network 28, such as a cloud computing service.

The HMI 40 may be operatively coupled to the processor 32 of computer 30 to enable a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query, where a query may be dynamically determined and executed by the operating system 44, other applications 46, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database.

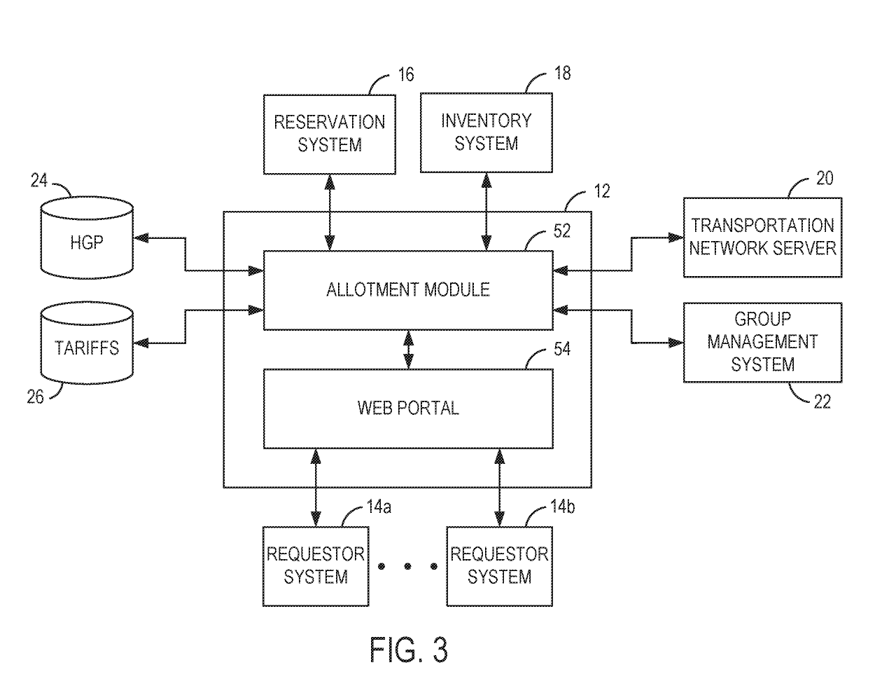

Referring now to FIG. 3, the allotment management system 12 may include an allotment module 52 and a web portal 54. The allotment module 52 may collect input data by receiving requests for allotments from requestor systems 14a, 14b, capacity data from the inventory system 18, data defining the transportation network such as nodes and routes connecting the nodes from the transportation network server 20, expected usage rates of allotments from the group management system 22, historical requestor performance data from the HGP database 24, and group fares from the tariffs database 26. Based on this input, the allotment module may determine optimal allotments among the group requests received from the requestor systems 14a, 14b. The allotment module 52 may then provide the optimized allotments to the provider for validation, and reserve the validated allotted capacity in the reservation system 16.

The web portal 54 may provide a user interface between the requestor systems 14a, 14b and the allotment module 52 that enables the requestor systems 14a, 14b to transmit group requests to the allotment module 52. The web portal 54 may also enable the allotment module 52 to transmit fare pattern recommendations and capacity allotments to the requestor systems 14a, 14b. Key performance indicators and dashboards maintained by the allotment module 52 may also be accessed through the user interface. Users may thereby monitor the impact of capacity assignments on the transportation network and the requestors. Data may be formatted depending on the system with which the allotment module 52 is communicating, and may be transmitted automatically between systems using Extensible Markup Language (XML), Electronic Data Interchange For Administration, Commerce and Transport (EDIFACT), or Web Service technology, for example.

The web portal 54 may include a graphical user interface that provides a user input capability for entering business rules and controls, and for providing the allotment module 52 with market elements such as a preferred requestor list. The graphical user interface may also enable users to override or otherwise adjust allotment recommendations made by the allotment module 52.

Periodically, the allotment module 52 may collect the group requests received from the requestor systems 14a, 14b. Each group request may define an origin node and a destination node, or “node pair”, and one or more dates on which a block of capacity connecting the node pair is desired. The group request may also identify the requestor, and whether the request is firm or pending. Available capacity for making allotments may be provided to the allotment module 52 as a snapshot of existing inventory that defines all negotiated block-spaces which can be allotted from the provider inventory to satisfy group requests.

The allotment module 52 may retrieve an expected number of the requested units that will be actually be used from the group management system 22, and group fares for pricing the units from the tariffs database 26. The historical data may indicate, for example, an actual number of units used from previous allotments verses the requested capacity of the corresponding group request. This data may be organized or otherwise searchable by the identity of the requestor. In any case, expected revenue for each allotment may be determined based at least in part on the previous usage data obtained from the HGP database 24, and the group fares obtained from the tariffs database 26.

The allotment module 52 may determine an optimal allotment of capacity between pending group requests for the next allotment period, and propose these allotments to the provider. The provider may validate or modify the proposed allotments before final approval. Once the allotments have been approved, the approved allotments may be provided to the requestors, and upon their acceptance of the allotments, capacity reserved in the reservation system 16. Capacity may be reserved, for example, by creating one or more reservation records for each allotment, and associating the reservation records with the corresponding group request. Contracts for group bookings may also be automatically generated so that requestors can submit the contracts to their customers in real time.

In operation, each group request g may define a quantity of units N_{g} (e.g., a number of seats), an origin node, a destination node, and one or more dates on which the units are needed. The group requests g may be received from one or more requestor systems 14a, 14b, and the allotment module 52 may determine an optimal allotment of capacity to satisfy the group requests g. The allotment may be from an inventory of perishable units (e.g., seats on flights) that connect node pairs defined in the group requests.

For each group request g, the allotment module 52 may determine an expected number of units EN_{g} that will actually be utilized, which may be different than the amount of capacity requested. EN_{g} may represent, for example, a number of passengers that are expected to board the aircraft prior to flight departure for the group request g. The expected number of units EN_{g} may be determined by the group management system 22 based on historical data, and may be based, at least in part, on the identity of the requestor. The group management system 22 may also determine a standard deviation σ_{g} for each expected number of units EN_{g} based on previous usage patterns.

Letting G represent a set of all group requests g between which available capacity is to be assigned, the allotment module 52 may partition set G into subsets S of group requests g based on one or more characteristics of the group requests gin the subset S. For example, in an embodiment of the invention, a portion of the group requests gin set G may have originated from requestors to which the provider is contractually obligated to provide capacity. In this exemplary case, subset S_{U} may be defined to contain all the group requests g for which an allotment is mandatory, in which case subset S̅_{U} would contain all the group requests g not in subset S_{U}, so that G=S_{U}+S̅_{U}.

Another type of subset may define a series of group requests S_{S}. A series of group requests may include group requests for recurrent units of capacity connecting a node pair at different times. For example, a series of group requests, or a “group series request”, may request 20 seats from New York to Boston each Monday, and 20 seats from Boston to New York each Friday in order to provide transportation for executives commuting between these cities on a weekly basis.

The allotment module 52 may also allow selective partitioning of set G into subsets having group requests g with different priorities. For example, a user may partition set G into a number (e.g., three) of subsets S_{A}, S_{B}, S_{C} so that set G=S_{A}, S_{B}, S_{C}. The group requests gin subset S_{A} may have higher priority than the group requests g in subset S_{B}, and the group requests g in subset S_{B} may have higher priority than the group requests g in subset S_{C}. This exemplary partitioning may be performed, for example, to differentiate group requests g originating from most-favored requestors (e.g., gold tour operators) from group requests g originating from less-favored requestors (e.g., silver tour operators) or least-favored requestors (e.g., discount tour operators). For each subset S_{A}, S_{B}, S_{C}, the allotment module 52 may define a corresponding weight α_{A}, α_{B}, α_{C}, with each weight having a positive value such that α_{A}≧α_{B}≧α_{C}≧0.

A route r may define a set of one or more segments that connect an origin node to a destination node at a specific time, with each segment comprising one or more directional links. For each group request g in the set G, the allotment module 52 may define a set R_{g} of routes r that satisfy the group request g. That is, set R_{g} may include each route r in the transportation network that connects the node pair defined by the group request g on each date defined by the group request g. The allotment module 52 may determine the routes r in set R_{g} by querying the inventory system 18 or transportation network server 20 for routes r that satisfy the parameters defined by the group request g.

For each route r in the set R_{g}, the allotment module 52 may query the tariffs database 26 to determine a per-unit fare fᵣ for each route r in the set R_{g}. The allotment module 52 may then associate each fare with its corresponding route r to generate a priced travel solution tsᵣ=(r,fᵣ). Thus, the allotment module 52 may have a fare fᵣ for each route r in set R_{g} for each group request g in set G. These fares fᵣ, routes r, and group requests g may be stored, for example, in a database for use in calculating allotments of capacity between the group requests g of set G.

For embodiments involving a transportation network of an air carrier, each directional link l may correspond to a leg, which connects a departure station to an arrival station without an intervening stop. Directional links may provide the elemental components from which the inventory system 18 defines segments and routes r in the transportation network. The inventory system 18 may define one or more sets L of directional links l, with each directional link l in the set L connecting specific departure and arrival nodes (e.g., airports) at a specific scheduled time. Each directional link l in the set L may have an available capacity cₗ, which may be based on an available physical capacity of the aircraft assigned to the corresponding leg, or defined by a revenue management system based on parameters such as the bid-price and/or the yield of a unit of capacity on the route r. Available capacity may also be a dedicated capacity reserved for group allotments, which may be less than the total capacity of the leg. The available capacity cₗ may change over time prior to departure based on the number of seats sold, the type of aircraft assigned to the leg, or changes in yield and bid-prices. In an embodiment of the invention, the available capacity cₗ may refer to a portion of a total capacity of the directional link l that is reserved for group allotments.

To determine an optimal allotment between each group request g in set G, the allotment module 52 may use one or more selector functions. One such selector function may be used by the allotment module 52 to control whether capacity on a route r is allotted to a particular group request g for the purpose of determining the expected revenue. The output of this selector function may be a logic value 1 or a logic value 0 for each group request g in set G and route r in set R_{g}, or each request-route pair (g, r), as shown by:

$$x ( g , r ) = \{ \begin{matrix}1 , & if ( r ∈ g ) \\ 0 , & otherwise\end{matrix}$$

The selector function x(g, r) may thereby provide the allotment module 52 with a mechanism for determining expected revenue for various capacity allotments from routes r to group requests g. An optimization algorithm may be provided by:

maxΣ_{gεG}{α_{g}×Σ_{rεI}_{_{g}}fᵣ×x(g,r)} Eqn. 1

The where selector function x(g, r) is defined to maximize the value of equation 1 while satisfying a set of user defined constraints. The selector function that maximizes equation 1 may be determined, for example, by calculating the value of equation 1 for a plurality of selector functions, ranking the selector functions based on their corresponding values, and selecting the highest ranked selector function.

Constraints may include, for example, a requirement that the total number of units allotted across all the group requests g cannot exceed the available capacity cₗ of any directional link l in set L. To facilitate this determination, a link selector function k(r, l) may be defined for each directional link l in set L of each route r in set R_{g} of each group request g in set G. The output of the link selector function k(r, l) may be a logical value 1 if directional link l is included in route r, and a logical value 0 if directional link l is not included in route r, as shown by:

$$k ( r , l ) = \{ \begin{matrix}1 , & if ( l ∈ r ) \\ 0 , & otherwise\end{matrix}$$

The link selector function k(r, l) may be used to provide a link capacity constraint by defining x(g, r) so that equation 2 is satisfied for all directional links l in the set L:

∀lεL, {Σ_{gεG}Max[S_{g},(EN_{g}+σ_{ES})]×Σ_{rεR}_{_{g}}k(r,l)×x(g,r)}≦cₗ Eqn. 2

Another exemplary constraint may involve requiring that certain group requests g be assigned one route r. This may be the case, for example, if the provider has a contract with the requestor requiring the provider to provide capacity to the requestor. This constraint may be satisfied by defining x(g, r) so that equation 3 is satisfied for all group requests in the set S_{U}:

∀gεS_{U}, Σ_{rεR}_{_{g}}x(g,r)=1 Eqn. 3

A related exemplary constraint may involve insuring that at most one route is selected for group requests g of lesser importance. This constraint may be satisfied by defining x(g, r) so that equation 4 is satisfied for all group requests in the set S_{U}:

∀gεS̅_{U}, Σ_{rεR}_{_{g}}x(g,r)≦1 Eqn. 4

Another exemplary constraint may require allotments either be provided to all group requests in a series of group requests, or to none of the group requests in the series of group requests. This constraint may be satisfied by defining x(g, r) so that equation 5 is satisfied for all group requests in the set G:

∀SεG, ∀gεS, Σ_{rεR}_{_{g}}x(g,r)=Σ_{rεR}_{_{g+1}}x(g+1,r) Eqn. 5

Another exemplary constraint may require that all variables have binary values. This constraint may be satisfied by defining x(g, r) so that equation 6 is satisfied for all group requests in the set G and all routes r in set R_{g}.

∀gεG, ∀rεR_{g}, x(g,r)ε{0,1} Eqn. 6

Additional constraints may be added to define a minimum number of group requests that should be accepted from a single requestor, or a maximum number of bookings that should be performed by a requestor, for example.

Structures may be used to design efficient heuristics for the above model to reduce the amount of time necessary for the allotment module 52 to determine a solution. For example, the number of columns may become large in practice, and an iterative column-generation approach may be used in some embodiments of the invention to reduce the size of the problem and thereby reduce processing time.

Embodiments of the invention may provide recommendations for allotting units of capacity to group requests that optimize revenue generated by a transportation network. Value may be optimized by a value function that relies on determining an expected revenue that would be generated by allotments to each group request. Because the amount of capacity required to satisfy all the group requests may exceed the available capacity for group allotments, the model may automatically arbitrate which group requests should be satisfied, and which group requests should be rejected. This determination may be based at least in part on an expected usage rate at the time of departure.

Requesters may be grouped according to their past performances as measured by a ratio of requested capacity to used capacity. The model may take into account actual use by allotting more capacity to requestors that have a history of selling large fractions of their requested capacity. The allotment module 52 may also calculate key performance indicators, such as expected revenue by requestor for the next allotment period and the ratio of group requests denied/allotted, to facilitate decision making by the provider.

Although depicted as being provided by the allotment management system 12, the allotment module 52 may be hosted by any suitable computer system, such as computer system operated by the provider. The allotment module 52 may include a dedicated interface, such as a portal or web service, that provides a data entry point where the requestor can provide data defining their demand for capacity. The output of allotment module 52 may be used to create booking containers for the allotment (e.g., group PNR or negotiated block-space). The allotment management system 12 may also include modules that enable the provider to generate a document summarizing the terms and conditions attached to the allotments proposed by the allotment module 52. This document may be sent automatically to the requestors once finalized. A fare pattern recommendation module may also be provided that enables the provider to generate a pricing catalogue that may be sent periodically (e.g., once a year) to the requestors. Operation of the fare pattern recommendation module may be facilitated by the key performance indicators and reports generated by the allotment module 52.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An allotment management system for allotting units of capacity from a network comprising a plurality of nodes connected by directional links, the system comprising:
one or more processors; and
a memory coupled to the one or more processors, the memory storing data comprising program code that, when executed by at least one of the one or more processors, causes the system to:
receive a plurality of requests for group allotments, each request defining a number of units and a node pair that includes an origin node and a destination node;
for each request, determine one or more routes, each route including one or more directional links that connect the node pair;
define a plurality of selector functions each identifying a plurality of request-route pairs that are satisfied without exceeding an available capacity of any of the directional links in the network;
determine a first value for each selector function that would be generated by allotting, for each request-route pair identified by the selector function, the number of units defined by the respective request from the respective route;
rank the selector functions based on the first values; and
allot the units to the requests identified by a highest ranked selector function.

2. The system of claim 1 wherein the program code causes the system to determine the first value for each of the selector functions by:
partitioning the requests into a first set of requests that have a first weight and a second set of requests that have a second weight; and
for each selector function:
for each request-route pair identified by the selector function:
determining a second value for each unit requested for the respective route,
summing the second values to produce a third value of the request, and
multiplying the third value by the first weight if the request belongs to the first set of requests, or the second weight if the request belongs to the second set of requests, to produce a product, and
summing the products to produce the first value of the selector function.

3. The system of claim 1 wherein the program code further causes the system to:
identify a series of requests from a requestor for recurrent units that connect a respective node pair at different times; and
further define the plurality of selector functions so that either all the requests in the series of requests are satisfied, or none of the requests in the series of requests are satisfied.

4. The system of claim 1 wherein the program code further causes the system to:
determine whether the available capacity of any of the directional links in the network is exceeded based on an expected number of units that will be utilized for each request identified by the selector function.

5. The system of claim 1 wherein the program code further causes the system to:
identify a first series of requests from a first requestor for recurrent units that connect a first respective node pair at different times; and
in response to the first series of requests being flagged as important, further define the plurality of selector functions so that each selector function allots capacity to each request in the first series of requests so that, for each request in the series of requests, the route is the same for each unit allotted to the request.

6. The system of claim 5 wherein the program code further causes the system to:
identify a second series of requests from a second requestor for recurrent units that connect a second respective node pair at different times;
in response to the second series of requests not being flagged as important, further define the plurality of selector functions so that each selector function allots capacity to each request in the second series of requests; and
if a selector function cannot be defined that allots capacity to each request in the second series of requests, cancel the group request.

7. The system of claim 1 wherein the program code further causes the system to:
in response to a time of use for an allotment expiring, store a number of units in the allotment and an actual number of units used from the allotment in a historical group performance database.

8. The system of claim 7 wherein the program code further causes the system to:
determine a performance of a requestor that received the allotment based at least in part on the number of units in the allotment and the actual number of units used from the allotment.

9. A method of allotting units of capacity in a network comprising a plurality of nodes connected by directional links, the method comprising:
receiving, at an allotment management system, a plurality of requests for group allotments, each request defining a number of units and a node pair that includes an origin node and a destination node;
for each request, determining, by the allotment management system, one or more routes, each route including one or more directional links that connect the node pair;
defining, by the allotment management system, a plurality of selector functions each identifying a plurality of request-route pairs that are satisfied without exceeding an available capacity of any of the directional links in the network;
determining, by the allotment management system, a first value for each selector function that would be generated by allotting, for each request-route pair identified by the selector function, the number of units defined by the respective request from the respective route;
ranking, by the allotment management system, the selector functions based on the first values; and
allotting, by the allotment management system, the units to the requests identified by a highest ranked selector function.

10. The method of claim 9 wherein determining the first value for each of the selector functions comprises:
partitioning the requests into a first set of requests that have a first weight and a second set of requests that have a second weight; and
for each selector function:
for each request-route pair identified by the selector function:
determining a second value for each unit requested for the respective route,
summing the second values to produce a third value of the request, and
multiplying the third value by the first weight if the request belongs to the first set of requests, or the second weight if the request belongs to the second set of requests, to produce a product, and
summing the products to produce the first value of the selector function.

11. The method of claim 9 further comprising:
identifying a series of requests from a requestor for recurrent units that connect a respective node pair at different times; and
further defining the plurality of selector functions so that either all the requests in the series of requests are satisfied, or none of the requests in the series of requests are satisfied.

12. The method of claim 9 further comprising:
determining whether the available capacity of any of the directional links in the network is exceeded based on an expected number of units that will be utilized for each request identified by the selector function.

13. The method of claim 12 further comprising:
determining the expected number of units that will be utilized based on a requested number of units and a standard deviation of a number of units that were utilized for previous requests from the requestor.

14. The method of claim 9 wherein the available capacity of each directional link is a dedicated capacity for the group allotments.

15. The method of claim 9 wherein the available capacity of each directional link is determined at least in part based on a yield of each unit.

16. The method of claim 9 further comprising:
identifying a first series of requests from a first requestor for recurrent units that connect a first respective node pair at different times; and
in response to the first series of requests being flagged as important, further defining the plurality of selector functions so that each selector function allots capacity from at least one route to each request in the first series of requests.

17. The method of claim 16 further comprising:
identifying a second series of requests from a second requestor for recurrent units that connect a second respective node pair at different times; and
in response to the second series of requests not being flagged as important, further defining the plurality of selector functions so that each selector function allots capacity from no more than one route to each request in the second series of requests.

18. The method of claim 9 further comprising:
in response to a time of use for an allotment expiring, storing a number of units in the allotment and an actual number of units used from the allotment in a historical group performance database.

19. The method of claim 18 further comprising:
determining a performance of a requestor that received the allotment based at least in part on the number of units in the allotment and the actual number of units used from the allotment.

20. A computer program product for allotting units of capacity in a network comprising a plurality of nodes connected by directional links, the computer program product comprising:
a non-transitory computer-readable storage medium; and
program code stored on the non-transitory computer-readable storage medium that, when executed by one or more processors, causes the one or more processors to:
receive a plurality of requests for group allotments, each request defining a number of units and a node pair that includes an origin node and a destination node;
for each request, determine one or more routes, each route including one or more directional links that connect the node pair;
define a plurality of selector functions each identifying a plurality of request-route pairs that are satisfied without exceeding an available capacity of any of the directional links in the network;
determine a first value for each selector function that would be generated by allotting, for each request-route pair identified by the selector function, the number of units defined by the respective request from the respective route;
ranking the selector functions based on the first values; and
allotting the units to the requests identified by a highest ranked selector function.
